(19) United States
(12) Patent Application Publication
(10) Pub. No.: US 2025/0382513 A1
(43) Pub. Date: Dec. 18, 2025

(54) MONOMERIC PURE 4,4' MDI ADHESIVE PREPOLYMER

(71) Applicant: Rohm and Haas Company, Collegeville, PA (US)

(72) Inventors: Dario Francesco Bartolini, Biandronno (IT); Pierluigi Pisoni, Arconate (IT); Vincenzo D'Ignoti, Legnano (IT)

(21) Appl. No.: 18/878,306

(22) PCT Filed: May 22, 2023
(86) PCT No.: PCT/US2023/023078

§ 371 Date: Dec. 23, 2024

(30) Foreign Application Priority Data
Jun. 30, 2022 (IT) 102022000013870

(51) Int. Cl. C09J 175/12; C08G 18/12

(52) U.S. Cl. CPC C09J 175/12; C08G 18/12

(57) ABSTRACT

The current disclosure relates to a solventless NCO terminated prepolymer comprising the reaction product of: (1) a pure nonmodified 4,4′ MDI, (2) a silane coupling agent capable of being grafted to a urethane prepolymer and (3) a polyol. The current disclosure also relates to a solventless NCO terminated prepolymer synthesized by: (1) first, mixing a polyol and a silane mg coupling agent capable of being grafted to a urethane prepolymer, then (2) adding pure 4,4′ MDI, (3) allowing the composition to react at temperature, and (4) cooling the product. Finally, the current disclosure relates to a method of synthesizing an NCO terminated prepolymer comprising: (1) first mixing a polyol and a silane coupling agent capable of being grafted to a urethane prepolymer, (2) adding a pure 4,4′ MDI, (3) allowing the composition to react at temperature, (4) cooling the product. An adhesive comprising the disclosed prepolymer and an OH terminated prepolymer is also disclosed.

### FIELD

The current disclosure relates to NCO terminated prepolymers and methods of production of NCO terminated prepolymers. More specifically, the current disclosure relates to solventless NCO terminated prepolymers comprising pure non modified 4,4′ MDI. The disclosed prepolymer can be used in the creation of adhesives.

### BACKGROUND

Adhesives can be based on the chemistry of polyurethane and are divided into two main categories: solvent based and solventless. Adhesives can be synthesized from an NCO based component and an OH based component. Solventless NCO based components can be synthesized by reacting monomeric MDI with polyether and/or polyester polyols producing NCO terminated prepolymers.

Conventionally, NCO terminated prepolymers are synthesized with an excess of isocyanate. Thus, by the end of the reaction, unreacted methylene diphenyl diisocyanate (MDI) dilutes the synthesized prepolymer. If 4,4′ MDI is used, the prepolymer is not stable. The inherent symmetry of 4,4′ MDI promotes, especially around 25° C., the formation of dimers. These dimers tend to go out of phase after production causing the prepolymer to become hazy.

As well, 4,4′ MDI is the most reactive of the MDI isomers that exist in nature. The final prepolymer is thus often difficult to handle after production.

One current solution to this problem involves modifying the 4,4′ MDI partially to carbodiimide and uretonimine. A poisoning agent is added to stop this conversion such as SnCl₂ when the required level of stabilization is achieved. The presence of these agents can prevent usage of the adhesive in food packaging applications. As well the modified 4,4′ MDI is, largely, still difficult to handle and extremely reactive.

The second current solution involves producing a 50:50 composition of 4,4′ MDI and 2,4′ MDI. Along with preventing dimer formation, the addition of the 2,4′ MDI decreases reactivity and increases ease of handling. However, 2,4′ MDI contains 2,2′ MDI which is extremely undesirable for food product applications and can cause problems passing PAA tests. Various methods have been developed to remove the 2,2′ MDI from 2,4′MDI but all increase the cost and complexity of prepolymer production.

Thus, a method of producing an NCO terminated prepolymer from pure 4,4′ MDI that avoids the production of dimers and subsequent falling out of phase is desirable.

### SUMMARY OF DISCLOSURE

The current disclosure relates to a solventless NCO terminated prepolymer comprising the reaction product of: (1) a pure nonmodified 4,4′ MDI, (2) a silane coupling agent capable of being grafted to a urethane prepolymer and (3) a polyl. The current disclosure also relates to a solventless NCO terminated prepolymer synthesized by: (1) first, mixing a polyol and a silane coupling agent capable of being grafted to a urethane prepolymer, then (2) adding pure 4,4′ MDI, (3) allowing the composition to react at temperature, and (4) cooling the product. Finally, the current disclosure relates to a method of synthesizing an NCO terminated prepolymer comprising: (1) first mixing a polyol and a silane coupling agent capable of being grafted to a urethane prepolymer, (2) adding a pure 4,4′ MDI, (3) allowing the composition to react at temperature, (4) cooling the product.

### BRIEF DESCRIPTION OF FIGURES

FIG. 1 is a picture of the CE1 prepolymer.

FIG. 2 is a picture of the CE2 prepolymer.

FIG. 3 is a picture of the IE1 prepolymer.

FIG. 4 is a picture of the IE2 prepolymer.

FIG. 5 is a graph showing the viscosity of a reference sample, a comparative sample, and two experimental samples as a function of time at 40° C. This value is commonly referred to as pot life.

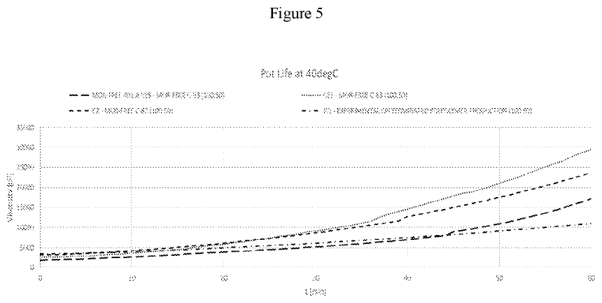

### DETAILED DESCRIPTION

As used herein, the term “prepolymer” means a monomer or system of monomers reacted to an intermediate state and capable of further polymerization. The term “pre-polymer” and “polymer precursor” will be used interchangeably herein.

As used herein, a “polyol” is a compound with two or more hydroxyl groups. A polyol with exactly two hydroxyl groups is a “diol” a polyol with exactly three hydroxyl groups is a “triol”.

As used herein, the term “polymer” means a polymeric compound prepared by polymerizing monomers or prepolymers, whether of the same or a different type. The generic term polymer thus embraces the term homopolymer (employed to refer to polymers prepared from only one type of monomer), and the term copolymer or interpolymer. Trace amounts of impurities (for example, catalyst residues) may be incorporated into and/or within the polymer. A polymer may be a single polymer, a polymer blend, or a polymer mixture, including mixtures of polymers that are formed in situ during polymerization.

As used herein, the term “polyolefin” means a polymer that comprises, in polymerized form, a majority amount of olefin monomer, for example ethylene or propylene (based on the weight of the polymer), and optionally may comprise one or more comonomers.

As used herein, the term “polyethylene” means a polymer comprising a majority amount (>50 mol %) of units which have been derived from ethylene monomer.

As used herein, the term “nonmodified 4,4′ methylene diphenyl diisocyanate” or “nonmodified 4,4′ MDI” means 4,4′ MDI that is not partially or completely converted to carbodiimide, uretonimine or any other chemical entity in an effort to prevent dimerization.

As used herein, the term “at temperature” refers to the process of bringing a composition to a certain temperature and maintaining the composition at that temperature until some process is completed.

As used herein, the term “pure” when used to describe 4,4′ methylene diphenyl diisocyanate or 4,4′ MDI means 4,4′ methylene diphenyl diisocyanate that contains no more than 2 wt. %, based on the weight of the 4,4′ MDI, 2,4′ methylene diphenyl diisocyanate.

The numerical ranges disclosed herein include all values from, and including, the lower and upper value. For ranges containing explicit values (e.g., a range from 1, or 2, or 3 to 5, or 6, or 7), any subrange between any two explicit values is included (e.g., the range 1 to 7 above includes subranges 1 to 2; 2 to 6; 5 to 7; 3 to 7; 5 to 6; etc.).

The term “composition” refers to a mixture of materials which comprise the composition, as well as reaction products and decomposition products formed from the materials of the composition.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

Currently disclosed is a solventless NCO terminated prepolymer comprised of the reaction product of (1) a pure nonmodified 4,4′ methylene diphenyl diisocyanate, (2) a silane coupling agent capable of being grafted to a urethane prepolymer, and (3) a polyol. While not being bound by theory, it is believed that the addition of the silane coupling agent capable of being grafted to a urethane prepolymer stabilizes the 4,4′ MDI and reduces reactivity to the point that dimers do not form and the prepolymer produced is clear as opposed to hazy.

Silane coupling agents are well known as promoters of adhesion between organic and inorganic substrates. Generally, in silane coupling agents, a silicon atom is bonded to both an organofunctional group and a hydrolysable group. The organofunctional group grafts to an organic substrate and the hydrolysable group bonds to inorganic substrates. A silane coupling agent can generally be considered as having the structure shown in structure 1:

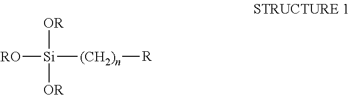

and have long been used as adhesion promotors. It has been unexpectedly discovered that a silane coupling agent capable of being grafted to a urethane prepolymer can act as a 4,4′ MDI stabilizer and a performance modulator. The silane coupling agent chosen can be those that generally work with thermoset urethanes. The silane coupling agent chosen can be amine or alkanolamine functional silanes. The silane coupling agent chosen can be capable of being grafted to a urethane prepolymer. The silane coupling agent chosen can comprise structure 1 wherein R is an amino, epoxy, carboxy, isocyanate, anhydride or urethane group. The silane coupling agent capable of being grafted to a urethane prepolymer can comprise (3-Aminopropyl)triethoxysilane.

The silane coupling agent capable of being grafted to a urethane prepolymer can comprise greater than 0.100 wt % based on the weight of the pure nonmodified 4,4′ methylene diphenyl diisocyanate, silane coupling agent capable of being grafted to a urethane prepolymer, and polyol composition. The silane coupling agent capable of being grafted to a urethane prepolymer can comprise greater than 0.500 wt % based on the weight of the pure nonmodified 4,4′ methylene diphenyl diisocyanate, silane coupling agent capable of being grafted to a urethane prepolymer, and polyol composition. The silane coupling agent capable of being grafted to a urethane prepolymer can comprise greater than 1.00 wt % based on the weight of the pure nonmodified 4,4′ methylene diphenyl diisocyanate, silane coupling agent capable of being grafted to a urethane prepolymer, and polyol composition. The silane coupling agent capable of being grafted to a urethane prepolymer can comprise greater than 1.50 wt % based on the weight of the pure nonmodified 4,4′ methylene diphenyl diisocyanate, silane coupling agent capable of being grafted to a urethane prepolymer, and polyol composition. The silane coupling agent capable of being grafted to a urethane prepolymer can comprise greater than 2.00 wt % based on the weight of the pure nonmodified 4,4′ methylene diphenyl diisocyanate, silane coupling agent capable of being grafted to a urethane prepolymer, and polyol composition. The silane coupling agent capable of being grafted to a urethane prepolymer can comprise greater than 2.50 wt % based on the weight of the pure nonmodified 4,4′ methylene diphenyl diisocyanate, silane coupling agent capable of being grafted to a urethane prepolymer, and polyol composition. The silane coupling agent capable of being grafted to a urethane prepolymer can comprise greater than 3.00 wt % based on the weight of the pure nonmodified 4,4′ methylene diphenyl diisocyanate, silane coupling agent capable of being grafted to a urethane prepolymer, and polyol composition. The silane coupling agent capable of being grafted to a urethane prepolymer can comprise greater than 3.50 wt % based on the weight of the pure nonmodified 4,4′ methylene diphenyl diisocyanate, silane coupling agent capable of being grafted to a urethane prepolymer, and polyol composition.

The silane coupling agent capable of being grafted to a urethane prepolymer can comprise between 0.100 and 1.50 wt. % based on the weight of the pure nonmodified 4,4′ methylene diphenyl diisocyanate, silane coupling agent capable of being grafted to a urethane prepolymer, and polyol composition. All individual values and subranges are included and disclosed. For example, the silane coupling agent capable of being grafted to a urethane prepolymer can comprise between 0.500 and 1.30 wt. % based on the weight of the pure nonmodified 4,4′ methylene diphenyl diisocyanate, silane coupling agent capable of being grafted to a urethane prepolymer, and polyol composition. The silane coupling agent capable of being grafted to a urethane prepolymer can comprise between 1.50 and 4.50 wt. % based on the weight of the pure nonmodified 4,4′ methylene diphenyl diisocyanate, silane coupling agent capable of being grafted to a urethane prepolymer, and polyol composition. All individual values and subranges are included and disclosed. For example, the silane coupling agent capable of being grafted to a urethane prepolymer can comprise between 2.00 and 4.00 wt. % based on the weight of the pure nonmodified 4,4′ methylene diphenyl diisocyanate, silane coupling agent capable of being grafted to a urethane prepolymer, and polyol composition.

Any pure nonmodified 4,4′ methyl diphenyl diisocyanate can be used. Suitable commercial sources include ISONATE™ 125MDR Pure MDI available from DOW™ chemical. The pure nonmodified 4,4′ MDI can comprise no more than 2 wt. % 2,4′ MDI. The pure nonmodified 4,4′ MDI can comprise no more than 1 wt. % 2,4′ MDI. The pure nonmodified 4,4′ MDI can comprise no more than 0.5 wt. % 2,4′ MDI. The pure nonmodified 4,4′MDI can comprise no more than 0.0 wt. % 2,4′ MDI.

The 4,4′ MDI can comprise 0.100 to 90.0 wt. % based on the weight of the pure nonmodified 4,4′ methylene diphenyl diisocyanate, silane coupling agent capable of being grafted to a urethane prepolymer, and polyol composition. All individual values and subranges are included and disclosed. For example, the 4,4′ MDI can comprise 40.0 to 50.0 wt. % based on the weight of the pure nonmodified 4,4′ methylene diphenyl diisocyanate, silane coupling agent capable of being grafted to a urethane prepolymer, and polyol composition.

Any polyol can be used including but not limited to polyether, polyester, polybutadiene, polycarbonate, biobased, and polyacrylate polyols. The polyol can comprise from 0.100 to 90.0 wt. % based on the weight of the pure nonmodified 4,4′ methylene diphenyl diisocyanate, silane coupling agent capable of being grafted to a urethane prepolymer, and polyol composition. All individual values and subranges are included and disclosed. For example, the polyol can comprise from 40.0 to 50.0 wt. % based on the weight of the pure nonmodified 4,4′ methylene diphenyl diisocyanate, silane coupling agent capable of being grafted to a urethane prepolymer, and polyol composition.

If reduction of the prepolymer's final viscosity is desired, an isomeric MDI isocyanate or a modified MDI isocyanate can be added post reaction. Isomeric MDIs suitable for use in the current disclosure include but are not limited to ISONATET™ OP 50 Pure MDI. Modified MDIs suitable for use in the current disclosure include but are not limited to ISONATE™ M143. The isomeric or modified MDI isocyanate is not participating in the reaction and is only added post reaction. The isomeric or modified MDI isocyanate does not participate in prepolymer synthesis. As such its usage is not required and it can be replaced with an equal amount of ISONATE™ 125MDR Pure MDI.

If PAA tests for food contact applications are a concern, no more than 7 wt. % ISONATE™ OP 50 Pure MDI can be used. Even if PAA tests for food contact applications are not a concern, using no more than 10 wt. % is advisable. ISONATE™ OP 50 Pure MDI can comprise less than 7.01 wt. % based on the weight of the pure nonmodified 4,4′ methylene diphenyl diisocyanate, silane coupling agent capable of being grafted to a urethane prepolymer, and polyol composition. ISONATE™ OP 50 Pure MDI can comprise less than 10.1 wt. % based on the weight of the pure nonmodified 4,4′ methylene diphenyl diisocyanate, silane coupling agent capable of being grafted to a urethane prepolymer, and polyol composition. ISONATE™ OP 50 Pure MDI can comprise from 0.000 to 10.0 wt. % based on the weight of the pure nonmodified 4,4′ methylene diphenyl diisocyanate, silane coupling agent capable of being grafted to a urethane prepolymer, and polyol composition. All individual values are included and disclosed. For example, the ISONATE™ OP 50 Pure MDI can comprise from 0.000 to 7.00 wt. % based on the weight of the pure nonmodified 4,4′ methylene diphenyl diisocyanate, silane coupling agent capable of being grafted to a urethane prepolymer, and polyol composition.

The solventless NCO terminated prepolymer can be synthesized by first mixing a polyol and a silane coupling agent capable of being grafted to a urethane prepolymer. Then adding a pure nonmodified 4,4′ methylene diphenyl diisocyanate. Allowing the composition to react at temperature and cooling the product. This is referred to as a Reverse Charge synthesis route. The MDI, polyol, and silane coupling agent capable of being grafted to a urethane prepolymer used are as described above.

This contrasts with the current state of the art direct charge route where the isocyanate is loaded first and then all the polyols are added. If silane coupling agent is added during synthesis following this route, a white material can be observed going out of phase almost as soon as the silane coupling agent is added. This is true if the silane coupling agent is added with all the polyols at the beginning of the reaction (direct charge), or if the silane coupling agent is added after all the polyols have been added and reacted with MDI to the desired NCO % in what is referred to as Direct Charge1. This white material is likely pure modified diisocyanate capped by a silane coupling agent.

The solventless NCO terminated prepolymer can be synthesized by loading liquified polyol into a reaction flask equipped with a stirrer, a reflux condenser, a thermometer, and a heating jacket. Once the polyol is mixed, a silane coupling agent is added and mixed into the composition. Liquified, pure 4,4′ nonmodified MDI is added when the mixing of the silane coupling agent is complete. Once the liquified, pure 4,4′ nonmodified MDI is mixed, the composition is allowed to react at temperature. Once the reaction is complete, modified MDI or isomeric MDI is added if desired, the composition is cooled, and the flask contents are discharged.

A solventless NCO terminated prepolymer that can be synthesized by first mixing a polyol and a silane coupling agent capable of being grafted to a urethane prepolymer. Then adding a pure nonmodified 4,4′ methylene diphenyl diisocyanate. Allowing the composition to react at temperature, and cooling the product is disclosed. This is referred to as a Reverse Charge synthesis route. The MDI, polyol, and silane coupling agent capable of being grafted to a urethane prepolymer used are as described above.

The solventless NCO terminated prepolymer can be synthesized by loading liquified polyol into a reaction flask equipped with a stirrer, a reflux condenser, a thermometer, and a heating jacket. Once the polyol is mixed a silane coupling agent is added and mixed into the composition. Liquified pure 4,4′ nonmodified MDI is added when the mixing of the silane coupling agent is complete. Once the liquified pure 4,4′ nonmodified MDI is mixed, the composition is allowed to react at temperature. Once the reaction is complete, modified MDI or isomeric MDI is added if desired, the composition is cooled, and the flask contents are discharged.

A method of synthesizing an NCO terminated prepolymer comprising first mixing a polyol and a silane coupling agent capable of being grafted to a urethane prepolymer, then adding a pure nonmodified 4,4′ methylene diphenyl diisocyanate, allowing the composition to react at temperature, and cooling the product is disclosed. The MDI, polyol, and silane coupling agent capable of being grafted to a urethane prepolymer used are as described above. This method is referred to as a Reverse Charge synthesis route.

The method of synthesizing an NCO terminated prepolymer can comprise loading liquified polyol into a reaction flask equipped with a stirrer, a reflux condenser, a thermometer, and a heating jacket. Mixing the polyol. Adding and mixing a silane coupling agent into the composition once the polyol is mixed. Adding liquified pure 4,4′ nonmodified MDI when the mixing of the silane coupling agent is complete. Mixing the composition once the pure 4,4′ nonmodified MDI is added. Allowing the composition to react at temperature under stirring once the liquified pure 4,4′ nonmodified MDI is mixed. Adding modified MDI or isomeric MDI if desired. Cooling the composition and discharging the flask contents.

An adhesive comprised of 1-99 wt. % of the currently disclosed solventless NCO terminated prepolymer and 1-99 wt. % of an OH terminated prepolymer can be produced. Production of adhesives from NCO terminated prepolymers and OH terminated prepolymers is well known in the art and discussed in D. C. Blackley, Emulsion Polymerization (Wiley, 1975); H. Warson, The Applications of Synthetic Resin Emulsions, Chapter 2 (Ernest Benn Ltd., London 1972); U.S. patent application US2008/0176996.

The separately produced prepolymers are brought into contact with each other and mixed together to create the adhesive. This mixing may take place at any suitable time in the process of forming the adhesive composition and applying the adhesive to a substrate, such as before, during, or as a result of the application process. This mixing can be carried out using a suitable conventional mixer, such as an electrically, pneumatically, or otherwise powered mechanical mixer.

### EXAMPLES

TABLE 1
Materials

| Component | Description | Producing Company |
|---|---|---|
| BESTER ™ 127 | Polyester polyol based on | DOW ™ Chemical Company |
| | adipic acid, neopentyl glycol, | |
| | and 1,6 hexanediol. | |
| BESTER ™ 104 | Polyester polyol based on | DOW ™ Chemical Company |
| | adipic acid, isophthalic acid, | |
| | and diethylene glycol. | |
| Castor Oil | Biobased polyol from | Campbell & Co. |
| | glycerol average OHᵥ 164 | |
| | mgKOH/g, max water content | |
| | of 0.25%. | |
| SILQUEST ™ A-1100 | aminopropyl triethoxysilane | MOMENTIVE ™ |
| | adhesion promoter. | performance materials |
| ISONATE ™ 125MDR Pure | Pure MDI mixture composed | DOW ™ Chemical Company |
| MDI | of approximately 98% 4,4′- | |
| | diphenylmethane | |
| | diisocyanate and 2% 2,4′ | |
| | diphenylmethane | |
| | diisocyanate. | |
| ISONATE ™ OP 50 Pure | Mixture composed of | DOW ™ Chemical Company |
| MDI | approximately 50% | |
| | 4,4′ diphenylmethane | |
| | diisocyanate and 50% | |
| | 2,4′ diphenylmethane | |
| | diisocyanate. | |
| VORANOL ™ CP 755 | polyether polyol based on | DOW ™ Chemical Company |
| POLYOL | propoxilated glycerol. | |
| MOR-FREETM 402A 81S | Solventless NCO terinated | DOW ™ Chemical Company |
| | prepolymer based on | |
| | Isomeric MDI | |
| MOR-FREE ™ C 83 | Solventless coreactant used | DOW ™ Chemical Company |
| solventless coreactnat | in combination with adhesive | |
| | systems. | |
| Experimental OH terminated | See below | NA |
| prepolymer | | |

TABLE 2
Formulations of Experimental and Inventive Samples

| | CE1 | CE2 | CE3 | CE4 | IE1 | IE2 | Experimental |
|---|---|---|---|---|---|---|---|
| | wt. % | wt. % | wt. % | wt. % | wt. % | wt. % | OH |
| | (direct | (reverse | (direct | (direct | (reverse | (reverse | Terminated |
| Component | charge) | charge) | charge) | charge1) | charge) | charge) | Prepolymer |
| BESTER ™ | 31.0 | 31.0 | 30.0 | 30.0 | 30.5 | 30.0 | — |
| 127 | | | | | | | |
| BESTER ™ | 9.00 | 9.00 | 8.00 | 8.00 | 8.75 | 8.00 | — |
| 104 | | | | | | | |
| Castor Oil | 9.00 | 9.00 | 8.00 | 8.00 | 8.75 | 8.00 | — |
| SILQUEST ™ | — | — | 3.00 | 3.00 | 1.00 | 3.00 | — |
| A-1100 | | | | | | | |
| ISONATE ™ | 44.0 | 44.0 | 44.0 | 44.0 | 44.0 | 44.0 | 11.0 |
| 125MDR Pure | | | | | | | |
| MDI | | | | | | | |
| ISONATE ™ | 7.00 | 7.00 | 7.00 | 7.00 | 7.00 | 7.00 | — |
| OP 50 Pure | | | | | | | |
| MDI | | | | | | | |
| VORANOL ™ | — | — | — | — | — | — | 89.0 |
| CP 775 | | | | | | | |
| POLYOL | | | | | | | |

Direct charge, direct charge1 and reverse charge refer to synthesis methods explained in the detailed description.

### Comparative Sample 1 (CE1) Production

In a reaction flask equipped with a stirrer, a reflux condenser, a thermometer, and a heating jacket, 1100 g of ISONATE™ 125MDR Pure MDI are loaded after having been pre-heated at 50° C. and liquified. The temperature is set to 55° C. and the system is put under stirring. 775 g of BESTERT™ 127 are heated in an oven at 50° C. and then loaded along with 225 g of BESTER™ 104, which is also heated in an oven at 50° C. before addition, and 225 g of castor oil. After the last addition, the temperature is set to 85° C. and the reaction is run for 2 hours and 30 min under stirring before checking via volumetric titration that the NCO % is in spec. While stirring is continued, the reaction flask is cooled down to 60° C. and 175 g of ISONATE™ OP 50 Pure MDI are added. After being mixed for 35 min at 60° C. the final NCO % is checked again via volumetric titration and the temperature is brought down to 45° C. before the reaction flask contents are discharged.

### Comparative Sample 2 (CE2) Production

In a reaction flask equipped with a stirrer, a reflux condenser, a thermometer, and a heating jacket, 775 g of BESTER™ 127 and 225 g of BESTER™ 104 are loaded at 40° C. under stirring, after having been pre-heated at 50° C. and liquified, along with 225 g of castor oil. The sample is then mixed for 35 min. 1100 g of ISONATE™ 125MDR Pure MDI are heated and liquified in an oven at 50° C. and loaded into the reaction flask. After the last addition, the temperature is set to 85° C. and the reaction is run for 3 hours under stirring before checking via volumetric titration that the NCO % is in spec. While stirring is continued, the reaction flask is cooled down to 60° C. and 175 g of ISONATE™ OP 50 Pure MDI are added. After being mixed for 35 min at 60° C., the final NCO % is checked again via volumetric titration and the temperature is brought down to 45° C. before the reaction flask contents are discharged.

### Comparative Sample 3 (CE3) Production

In a reaction flask equipped with a stirrer, a reflux condenser, a thermometer, and a heating jacket, 1100 g of ISONATE™ 125MDR Pure MDI are loaded after having been pre-heated at 50° C. and liquified. The temperature is set to 55° C. and the system is put under stirring. 750 g of BESTER™ 127 are heated in an oven at 50° C. and then loaded followed by 200 g of BESTER™ 104, which is also heated in an oven at 50° C. before addition, 200 g of castor oil, and 75 g of SILQUEST™ A-1100 (at this point white material went quickly out of phase). After the last addition, the temperature is set to 85° C. and the reaction is run for 3 hours under stirring before checking via volumetric titration that the NCO % is in spec. While stirring is continued, the reaction flask is cooled down to 60° C. and 175 g of ISONATE™ OP 50 Pure MDI are added. The temperature is then brought down to 45° C. before the reaction flask contents are discharged.

### Comparative Sample 4 (CE4) Production

In a reaction flask equipped with a stirrer, a reflux condenser, a thermometer, and a heating jacket, 1100 g of iSONATE™ 125MDR Pure MDI are loaded after having been pre-heated at 50° C. and liquified. The temperature is set to 55° C. and the system is put under stirring. 750 g of BESTER™ 127 are heated in an oven at 50° C. and then loaded followed by 200 g of BESTER™ 104, which is also heated in an oven at 50° C. before addition, and 225 g of castor oil. After the last addition, the temperature is set to 85° C., and the reaction is run for 2 hours and 30 min under stirring before checking via volumetric titration that the NCO % is in spec. While stirring is continued, the reaction flask is cooled to 60° C. and 75 g of Silquest A-1100 are subsequently added (at this point white material quickly goes out of phase). The temperature is then set back to 85° C. and the composition is kept under stirring at temperature for 60 min. While stirring is continued, the reaction flask is cooled down to 60° C. and 175 g of ISONATE™ OP 50 Pure MDI are added. The temperature is then brought down to 45° C. before the reaction flask contents are discharged.

### Inventive Sample 1 (IE1) Production

In a reaction flask equipped with a stirrer, a reflux condenser, a thermometer, and a heating jacket, 762.5 g of BESTER™ 127 and 218.8 g of BESTER™ 104 are loaded at 40° C. under stirring, after having been pre-heated at 50° C. and liquified, along with 218.8 g of castor oil. The sample is then mixed for 35 min. 25 g of SILQUEST™ A-1100 are then loaded at 40° C. under stirring and the sample is mixed for 55 min. 1100 g of ISONATE™ 125MDR Pure MDI are heated and liquified in an oven at 50° C. and loaded into the reaction flask. After the last addition, the temperature is set to 85° C. and the reaction is run for 3 hours under stirring before checking via volumetric titration that the NCO % is in spec. While stirring is continued, the reaction flask is cooled down to 60° C. and 175 g of ISONATE™ OP 50 Pure MDI are added. After being mixed for 35 min at 60° C., the final NCO % is checked again via volumetric titration and the temperature is brought down to 45° C. before the reaction flask contents are discharged.

### Inventive Sample 2 (IE2) Production

In a reaction flask equipped with a stirrer, a reflux condenser, a thermometer, and a heating jacket, 750 g of BESTER™ 127 and 200 g of BESTER™ 104 are loaded at 40° C. under stirring, after having been pre-heated at 50° C. and liquified, along with 200 g of castor oil. The sample is then mixed for 35 min. 75 g of SILQUEST™ A-1100 are then loaded at 40° C. under stirring and the sample is mixed for 55 min. 1100 g of ISONATE™ 125MDR Pure MDI are heated and liquified in an oven at 50° C. and loaded into the reaction flask. After the last addition, the temperature is set to 85° C. and the reaction is run for 3 hours under stirring before checking via volumetric titration that the NCO % is in spec. While stirring is continued, the reaction flask is cooled down to 60° C. and 175 g of ISONATE™ OP 50 Pure MDI are added. After being mixed for 35 min at 60° C., the final NCO % is checked again via volumetric titration and the temperature is brought down to 45° C. before the reaction flask contents are discharged.

### Experimental Oh Terminated Prepolymer Production

In a reaction flask equipped with a stirrer, a reflux condenser, a thermometer, and a heating jacket, 2225 g of VORANOL™ CP 775 POLYOL are loaded at 55° C. under stirring and mixed for 60 min. 275 g of ISONATE™ 125MDR Pure MDI are pre-heated and liquified in an oven at 50° C. and then loaded into the reaction flask. The temperature is then set to 60° C. for ten minutes. Before being raised to 85° C. The reaction is stirred for 2 hours before an NCO % of 0 is confirmed by volumetric titration. While stirring is continued, the reaction flask is then cooled to 40° C. before contents are discharged.

TABLE 3
Properties of Inventive and Comparative Samples

| NCO | Synthesis | MDI | Visual Aspect | Viscosity [cP] @ 25° C. |
|---|---|---|---|---|
| MOR-FREE 402 A | 1 step | Isomeric | Clear | 6500-11000 |
| 81S | Direct Charge | | | |
| CE1 | 1 step + OP50 add. | Pure MDI | Hazy | 9500 |
| | Direct Charge | | | |
| CE2 | 1 step + OP50 add. | Pure MDI | Hazy | 8800 |
| | Reverse Charge | | | |
| CE3 | 1 step + OP50 add. | Pure MDI | Hazy | n/a |
| | Direct Charge | | White material goes | |
| | | | out of phase when | |
| | | | silane coupling agent | |
| | | | is added | |
| CE4 | 2 steps + OP50 add. | Pure MDI | Hazy | n/a |
| | Direct Charge1 | | White material goes | |
| | | | out of phase when | |
| | | | silane coupling agent | |
| | | | is added | |
| IE1 | 1 step + OP50 add. | Pure MDI | Clear | 10200 |
| | Reverse Charge | | | |
| IE2 | 1 step + OP50 add. | Pure MDI | Clear | 12600 |
| | Reverse Charge | | | |

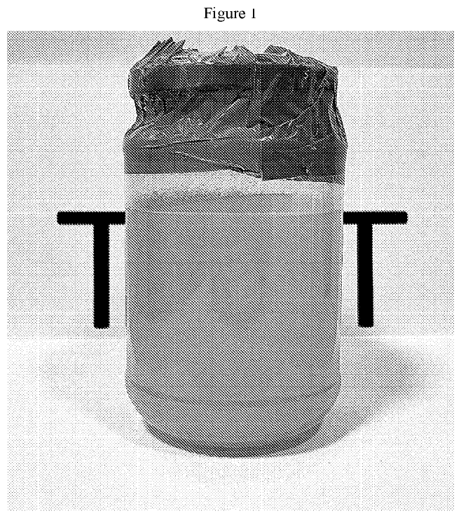

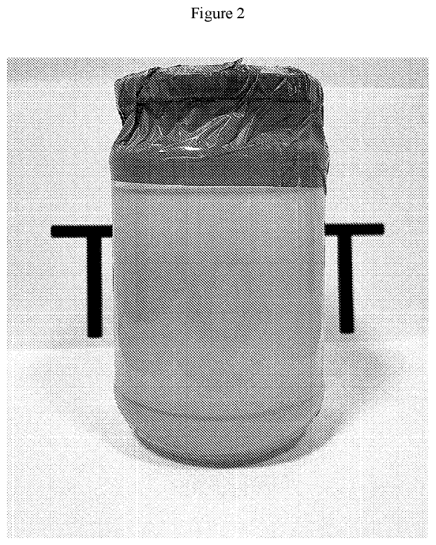

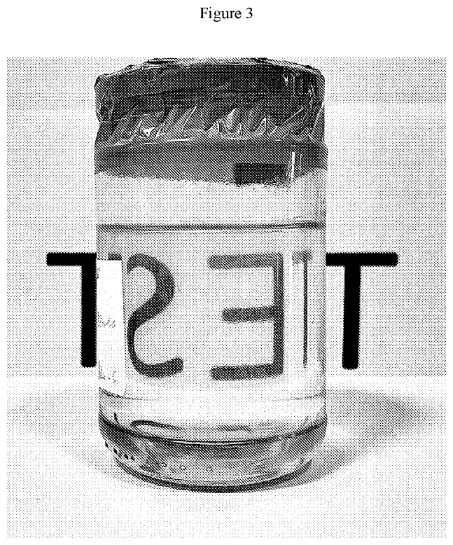

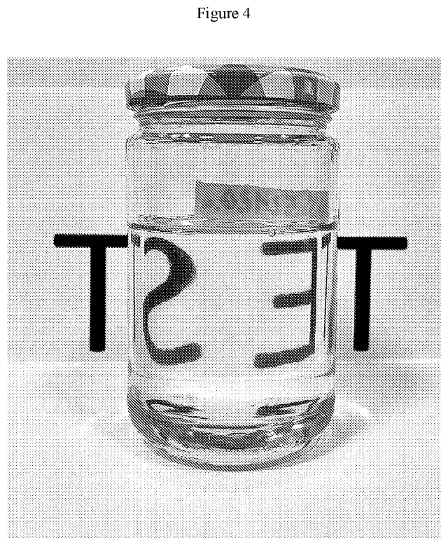

FIGS. 1 and 2 show the hazy samples produced using CE1 and CE 2 respectively while FIGS. 3 and 4 show the clear samples produced when IE1 and IE2 are used. This combined with the data above in Table 3 shows it is possible to obtain a stable NCO terminated prepolymer that is based on monomeric, pure, unmodified 4,4′ MDI when a silane coupling agent is used during prepolymer synthesis.

TABLE 4
Evolution of Pot Life at 40° C.

| MOR-FREE 402 A | | | | | | IE2-Experimental | |
|---|---|---|---|---|---|---|---|
| 81S - MOR-FREE C- | | CE1-MOR-FREE C- | | IE2-MOR-FREE C- | | OH Terminated | |
| 83 (100:50) | | 83 (100:50) | | 83 (100:50) | | Prepolymer | |
| t[min] | Visc.[cP] | t[min] | Visc.[cP] | t[min] | Visc.[cP] | t[min] | Visc.[cP] |
| 0 | 1894 | 0 | 2645 | 0 | 3163 | 0 | 3413 |
| 1 | 1942 | 1 | 2650 | 1 | 3200 | 1 | 3438 |
| 2 | 1998 | 2 | 2680 | 2 | 3250 | 2 | 3463 |
| 3 | 2063 | 3 | 2740 | 3 | 3325 | 3 | 3500 |
| 4 | 2136 | 4 | 2820 | 4 | 3425 | 4 | 3550 |
| 5 | 2215 | 5 | 2915 | 5 | 3525 | 5 | 3613 |
| 6 | 2301 | 6 | 3025 | 6 | 3650 | 6 | 3675 |
| 7 | 2392 | 7 | 3150 | 7 | 3775 | 7 | 3738 |
| 8 | 2487 | 8 | 3290 | 8 | 3913 | 8 | 3800 |
| 9 | 2587 | 9 | 3435 | 9 | 4050 | 9 | 3888 |
| 10 | 2691 | 10 | 3590 | 10 | 4213 | 10 | 3963 |
| 11 | 2798 | 11 | 3760 | 11 | 4375 | 11 | 4050 |
| 12 | 2908 | 12 | 3940 | 12 | 4538 | 12 | 4138 |
| 13 | 3021 | 13 | 4125 | 13 | 4700 | 13 | 4225 |
| 14 | 3135 | 14 | 4325 | 14 | 4888 | 14 | 4313 |
| 15 | 3252 | 15 | 4530 | 15 | 5075 | 15 | 4413 |
| 16 | 3370 | 16 | 4740 | 16 | 5275 | 16 | 4513 |
| 17 | 3489 | 17 | 5113 | 17 | 5475 | 17 | 4613 |
| 18 | 3610 | 18 | 5363 | 18 | 5675 | 18 | 4713 |
| 19 | 3733 | 19 | 5625 | 19 | 5900 | 19 | 4825 |
| 20 | 3856 | 20 | 5875 | 20 | 6113 | 20 | 4925 |
| 21 | 3981 | 21 | 6150 | 21 | 6338 | 21 | 5038 |
| 22 | 4108 | 22 | 6450 | 22 | 6575 | 22 | 5150 |
| 23 | 4235 | 23 | 6763 | 23 | 6813 | 23 | 5250 |
| 24 | 4365 | 24 | 7088 | 24 | 7050 | 24 | 5375 |
| 25 | 4496 | 25 | 7425 | 25 | 7313 | 25 | 5488 |
| 26 | 4630 | 26 | 7750 | 26 | 7575 | 26 | 5600 |
| 27 | 4766 | 27 | 8100 | 27 | 7838 | 27 | 5725 |
| 28 | 4905 | 28 | 8438 | 28 | 8113 | 28 | 5838 |
| 29 | 5047 | 29 | 8788 | 29 | 8400 | 29 | 5975 |
| 30 | 5193 | 30 | 9163 | 30 | 8688 | 30 | 6100 |
| 31 | 5343 | 31 | 9413 | 31 | 8975 | 31 | 6225 |
| 32 | 5498 | 32 | 9813 | 32 | 9288 | 32 | 6363 |
| 33 | 5659 | 33 | 10225 | 33 | 9600 | 33 | 6500 |
| 34 | 5825 | 34 | 10638 | 34 | 9925 | 34 | 6638 |
| 35 | 5999 | 35 | 11050 | 35 | 10250 | 35 | 6775 |
| 36 | 6180 | 36 | 11475 | 36 | 10588 | 36 | 6913 |
| 37 | 6369 | 37 | 12575 | 37 | 10938 | 37 | 7063 |
| 38 | 6568 | 38 | 13400 | 38 | 11300 | 38 | 7200 |
| 39 | 6777 | 39 | 14000 | 39 | 11663 | 39 | 7350 |
| 40 | 6997 | 40 | 14600 | 40 | 12700 | 40 | 7500 |
| 41 | 7229 | 41 | 15250 | 41 | 13200 | 41 | 7650 |
| 42 | 7474 | 42 | 15900 | 42 | 13600 | 42 | 7800 |
| 43 | 7734 | 43 | 16550 | 43 | 14100 | 43 | 7950 |
| 44 | 8009 | 44 | 17200 | 44 | 14500 | 44 | 8113 |
| 45 | 8940 | 45 | 17900 | 45 | 15000 | 45 | 8275 |
| 46 | 9289 | 46 | 18600 | 46 | 15500 | 46 | 8438 |
| 47 | 9661 | 47 | 18850 | 47 | 15950 | 47 | 8600 |
| 48 | 10056 | 48 | 19500 | 48 | 16450 | 48 | 8775 |
| 49 | 10476 | 49 | 20250 | 49 | 17000 | 49 | 8950 |
| 50 | 10923 | 50 | 21000 | 50 | 17550 | 50 | 9138 |
| 51 | 11398 | 51 | 21800 | 51 | 18050 | 51 | 9300 |
| 52 | 11903 | 52 | 22550 | 52 | 18650 | 52 | 9488 |
| 53 | 12439 | 53 | 23400 | 53 | 19200 | 53 | 9663 |
| 54 | 13008 | 54 | 24200 | 54 | 19800 | 54 | 9863 |
| 55 | 13612 | 55 | 25050 | 55 | 20450 | 55 | 10050 |
| 56 | 14253 | 56 | 25950 | 56 | 21050 | 56 | 10238 |
| 57 | 14933 | 57 | 26800 | 57 | 21700 | 57 | 10438 |
| 58 | 15654 | 58 | 27750 | 58 | 22350 | 58 | 10638 |
| 59 | 16418 | 59 | 28600 | 59 | 23050 | 59 | 10838 |
| 60 | 17226 | 60 | 29550 | 60 | 23750 | 60 | 11038 |

### Pot Life Testing Procedure

In a typical experiment, the selected adhesive system is premixed according to the mix ratio in Table 3 at room temperature for 1 minute. Subsequently, 20 grams of mixed adhesive is placed in a HT-2DB-100 aluminum cuvette and the cuvette is placed in a Brookfield D-III programmable rheometer and brought to 40° C. Using a SC4-28 spindle, the rheometer monitors the viscosity increase overtime at a speed of 100 rpm until a torque of 95% is reached, then 40 rpm until a torque of 95% is reached and finally 10 rpm until a torque of 95% is reached.

TABLE 5
Machine Life Cleaning Test

| | | | Machine Life | |
|---|---|---|---|---|
| NCO | OH | Mix Ratio | (min) | Whitening |
| MOR-FREE | MOR-FREE C-83 | 100-50 | 180 | no |
| 402 A 81S | | | | |
| CE1 | MOR-FREE C-83 | 100-50 | 60 | yes (strong) |
| CE2 | Experimental OH | 100-90 | 90 | yes (strong) |
| | Terminated Prepolymer | | | |
| CE3 | MOR-FREE C-83 | 100-50 | 120 | yes (slight) |
| CE4 | Experimental OH | 100-90 | 165 | yes (slight) |
| | Terminated Prepolymer | | | |
| IE1 | MOR-FREE C-83 | 100-50 | 120 | no |
| IE2 | Experimental OH | 100-90 | 165 | no |
| | Terminated Prepolymer | | | |

### Machine Life Cleaning Test Procedure

In a typical experiment, the selected adhesive systems are premixed according to the mix ratio in Table 5 at room temperature for 1 minute and subsequently deposited on the stationary cylinder of the Nordmeccanica Duplex SL 1-Shot solventless laminator which is previously set to 40° C. Usually, 20 g of each mixed adhesive system to be tested is laid on the cylinder. Each separate sample is laid on a separately marked spot before the test starts. The systems are left for 60 min after which all are checked for visual aspect and whitening while the viscosity increase is checked through touching the adhesive systems while a rubber glove is worn. Cleaning of any adhesive system that has almost completely hardened after 60 min with ethyl acetate is attempted. If cleaning is possible within 2 min, then the machine life is rated at 60 min. If cleaning takes longer than 2 min, machine life is rated at 45 min. If cleaning with ethyl acetate is not possible, then a dedicated cleaning product is used and machine life is rated at 45 min. All adhesive systems that sill need to harden after 60 min are left on the cylinder for an additional 30 min after which the same procedure described above is performed on all of those that feel like they have almost completely hardened. This 30 minute wait and test procedure is repeated until all samples feel like they have almost completely hardened.

1. A solventless NCO terminated prepolymer comprising the reaction product of:
a. a pure nonmodified 4,4′ methylene diphenyl diisocyanate
b. a silane coupling agent capable of being grafted to a urethane prepolymer
c. a polyol.

2. The solventless NCO terminated prepolymer of claim 1, wherein the solventless NCO terminated prepolymer is stable and non-dimeric and where a minimum of pure modified diisocyanate capped by a silane coupling agent is produced such that the synthesized solventless NCO terminated prepolymer is clear in liquid form.

3. The solventless NCO terminated prepolymer of claim 1, wherein the silane coupling agent capable of being grafted to a urethane prepolymer comprises greater than 0.1 wt % based on the weight of the pure nonmodified 4,4′ methylene diphenyl diisocyanate, silane coupling agent capable of being grafted to a urethane prepolymer, and polyol composition.

4. The solventless NCO terminated prepolymer of claim 1, wherein the silane coupling agent capable of being grafted to a urethane prepolymer has the following structure and wherein R is an amino, epoxy, carboxy, isocyanate, anhydride, or urethane group:

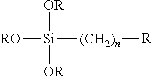

5. The solventless NCO terminated prepolymer of claim 1, wherein the silane coupling agent capable of being grafted to a urethane prepolymer is (3-aminopropyl)triethoxysilane.

6. The solventless NCO terminated prepolymer of claim 1, wherein the NCO terminated prepolymer is not the reaction product of a composition containing more than 2 wt. %, based on the weight of the pure nonmodified 4,4′ methylene diphenyl diisocyanate, silane coupling agent capable of being grafted to a urethane prepolymer, and polyol composition, 2,4′ methylene diphenyl diisocyanate.

7. A solventless NCO terminated prepolymer synthesized by:
a. first, mixing a polyol and a silane coupling agent capable of being grafted to a urethane prepolymer
b. then adding pure nonmodified 4,4′ methylene diphenyl diisocyanate
c. allowing the composition to react at temperature
d. cooling the product

8. The solventless NCO terminated prepolymer of claim 7, wherein the silane coupling agent capable of being grafted to a urethane prepolymer comprises greater than 0.1 wt % based on the weight of the pure nonmodified 4,4′ methylene diphenyl diisocyanate, silane coupling agent capable of being grafted to a urethane prepolymer, and polyol composition.

9. The solventless NCO terminated prepolymer in claim 7, wherein the silane coupling agent capable of being grafted to a urethane prepolymer has the following structure and wherein R is an amino, epoxy, carboxy, isocyanate, anhydride, or urethane group:

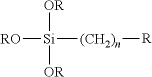

10. The solventless NCO terminated prepolymer of claim 7, wherein the silane coupling agent capable of being grafted to a urethane prepolymer is (3-aminopropyl)triethoxysilane.

11. The solventless NCO terminated prepolymer of claim 7, wherein the solventless NCO terminated prepolymer is not the reaction product of a composition containing more than 2 wt. %, based on the weight of the pure nonmodified 4,4′ methylene diphenyl diisocyanate, silane coupling agent capable of being grafted to a urethane prepolymer, and polyol composition, 2,4′ methylene diphenyl diisocyanate.

12. A method of synthesizing an NCO terminated prepolymer comprising:
a. first, mixing a polyol and a silane coupling agent capable of being grafted to a urethane prepolymer;
b. then, adding a pure nonmodified 4,4′ methylene diphenyl diisocyanate;
c. allowing the composition to react at temperature; and
d. cooling the product.

13. The method of claim 12, wherein the silane coupling agent capable of being grafted to a urethane prepolymer comprises greater than 0.1 wt % based on the weight of the pure nonmodified 4,4′ methylene diphenyl diisocyanate, silane coupling agent capable of being grafted to a urethane prepolymer, and polyol composition.

14. The method of claim 12, wherein the silane coupling agent capable of being grafted to a urethane prepolymer has the following structure and wherein R is an amino, epoxy, carboxy, isocyanate, anhydride, or urethane group:

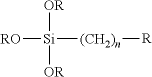

15. The method of claim 12, wherein the silane coupling agent is (3-aminopropyl)triethoxysilane.

16. The method of claim 12, wherein the NCO terminated prepolymer is not the reaction product of a composition containing more than 2 wt. %, based on the weight of the pure nonmodified 4,4′ methylene diphenyl diisocyanate, silane coupling agent capable of being grafted to a urethane prepolymer, and polyol composition, 2,4′ methylene diphenyl diisocyanate.

17. An adhesive comprising the reaction product of:
a. 1-99 wt. %, based on the weight of the reaction mixture, the solventless NCO terminated prepolymer of claim 1, and
b. 1-99 wt. %, based on the weight of the reaction mixture, an OH terminated prepolymer.
